(19) United States
(12) Patent Application Publication
(10) Pub. No.: US 2009/0145132 A1
(43) Pub. Date: Jun. 11, 2009

(54) METHODS AND SYSTEM FOR REDUCING PRESSURE LOSSES IN GAS TURBINE ENGINES

(75) Inventors: David M. Johnson, Simpsonville, SC (US); Ronald S. Bunker, Niskayuna, NY (US); Kenneth N. Whaling, Simpsonville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/952,165

(22) Filed: Dec. 7, 2007

(51) Int. Cl. F02C 1/00

(52) U.S. Cl. 60/755

(57) ABSTRACT

A method of assembling a combustor assembly is provided, wherein the method includes providing a combustor liner having a centerline axis and defining a combustion chamber therein, and coupling an annular flowsleeve radially outward from the combustor liner such that an annular flow path is defined substantially circumferentially between the flowsleeve and the combustor finer. The method also includes orienting the flowsleeve such that a plurality of inlets formed within the flowsleeve are positioned to inject cooling air in a substantially axial direction into the annular flow path to facilitate cooling the combustor finer.

This invention is related to U.S. patent application Ser. No. 11/227,600, filed Apr. 24, 2006.

### BACKGROUND OF THE INVENTION

This invention relates generally to gas turbine engines and more particularly, to combustor assemblies and related structures for use with gas turbine engines.

At least some known gas turbine engines use cooling air to cool a combustion assembly within the engine. Moreover, often the cooling air is supplied from a compressor coupled in flow communication with the combustion assembly. More specifically in at least some known gas turbine engines, the cooling air is discharged from the compressor into a plenum extending at least partially around a transition piece of the combustor assembly. A first portion of the cooling air entering the plenum is supplied to an impingement sleeve surrounding the transition piece prior to entering a cooling channel defined between the impingement sleeve and the transition piece. Cooling air entering the cooling channel is discharged into a second cooling channel defined between a combustor liner and a flowsleeve. The remaining cooling air entering the plenum is channeled through inlets defined within the flowsleeve prior to also being discharged into the second cooling channel.

Within the second cooling channel, the cooling air facilitates cooling the combustor liner. At least some known flowsleeves include inlets and thimbles that are configured to discharge the cooling air into the second cooling channel at an angle that is substantially perpendicular to the flow of the first portion of cooling air entering the second cooling chamber. More specifically, because of the different flow orientations, the second portion of cooling air loses axial momentum and may create a barrier to the momentum of the first portion of cooling air. The barrier may cause substantial dynamic pressure losses in the air flow through the second cooling channel.

At least one known approach to decreasing the amount of pressure losses requires reconfiguring inlets in a combustor system. However, this approach may require multiple inlets to be reconfigured at multiple sections of the engine. As such, the system economics of this approach may outweigh any potential benefits.

### BRIEF DESCRIPTION OF THE INVENTION

In one aspect, TO BE FINALIZED WRT CLAIMS

In another aspect, TO BE FINALIZED WRT CLAIMS

In a further aspect, TO BE FINALIZED WRT CLAIMS

These and other aspects, advantages and salient features of the invention will become apparent from the following detailed description, which, when taken in conjunction with the annexed drawings, where like pails are designated by like reference characters throughout the drawings, disclose embodiments of the invention.

### BRIEF DESCRIPTION OF THE DRAWINGS

FIG. 1 is a schematic cross-sectional illustration of an exemplary gas turbine engine;

FIG. 2 is an enlarged cross-sectional illustration of a portion of an exemplary combustor assembly that may be used with the gas turbine engine shown in FIG. 1;

FIG. 3 is a perspective illustration of a known flowsleeve that may be used with the combustor assembly shown in FIG. 2;

FIG. 4 is a perspective illustration of an exemplary flowsleeve that may be used with the combustor assembly shown in FIG. 2;

FIG. 5 is a cross-sectional illustration of an exemplary flowsleeve and an impingement sleeve/flowsleeve interface that may be used with the combustor assembly shown in FIG. 2;

FIG. 6 is a perspective illustration of an exemplary combustor liner that may be used with the combustor assembly shown in FIG. 2;

FIG. 7 is another cross-sectional illustration of an exemplary flowsleeve and an impingement sleeve/flowsleeve interface that may be used with the combustor assembly shown in FIG. 2; and

FIG. 8 is a further cross-sectional illustration of an exemplary flowsleeve and an impingement sleeve/flowsleeve interface that may be used with the combustor assembly shown in FIG. 2;

FIG. 9 is yet a further cross-sectional illustration of an exemplary flowsleeve and an impingement sleeve/flowsleeve interface that may be used with the combustor assembly shown in FIG. 2; and

FIG. 10 is still another cross-sectional illustration of an exemplary flowsleeve and an impingement sleeve/flowsleeve interface that may be used with the combustor assembly shown in FIG. 2.

### DETAILED DESCRIPTION OF THE INVENTION

As used herein, “upstream” refers to a forward end of a gas turbine engine, and “downstream” refers to an aft end of a gas turbine engine.

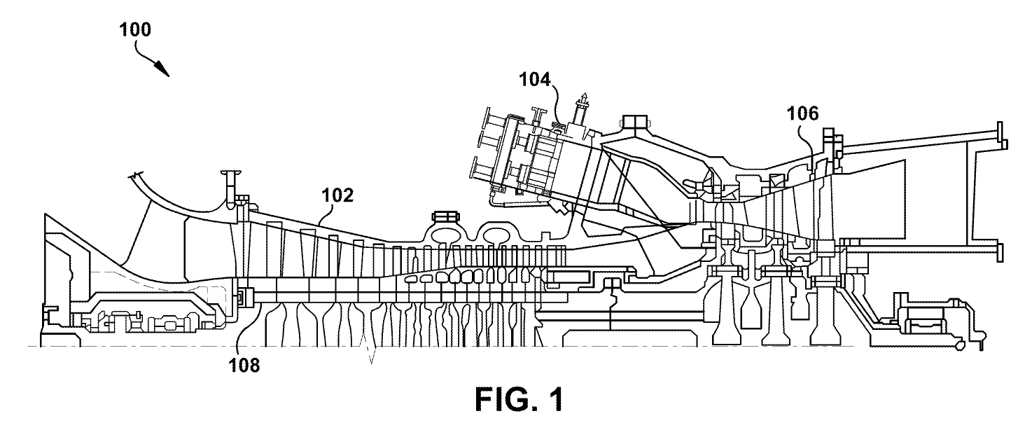

FIG. 1 is a schematic cross-sectional illustration of an exemplary gas turbine engine 100. Engine 100 includes a compressor assembly 102, a combustor assembly 104, a turbine assembly 106 and a common compressor/turbine rotor shaft 108. It should be noted that engine 100 is exemplary only, and that the present invention is not limited to engine 100 and may instead be implemented within any gas turbine engine that functions as described herein.

In operation, air flows through compressor assembly 102 and compressed air is discharged to combustor assembly 104. Combustor assembly 104 injects fuel, for example, natural gas and/or fuel oil, into the air flow, ignites the fuel-air mixture to expand the fuel-air mixture through combustion and generates a high temperature combustion gas stream. Combustor assembly 104 is in flow communication with turbine assembly 106, and discharges the high temperature expanded gas stream into turbine assembly 106. The high temperature expanded gas stream imparts rotational energy to turbine assembly 106 and because turbine assembly 106 is rotatably coupled to rotor 108, rotor 108 subsequently provides rotational power to compressor assembly 102.

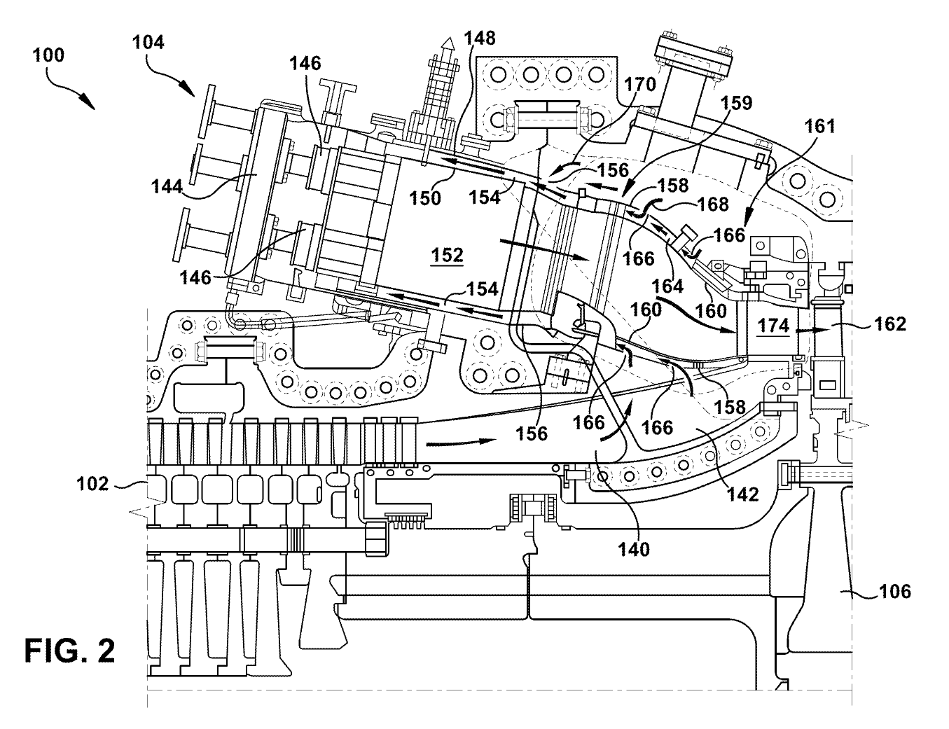

FIG. 2 is an enlarged cross-sectional illustration of a portion of combustor assembly 104. Combustor assembly 104 is coupled in flow communication with turbine assembly 106 and with compressor assembly 102. Compressor assembly 102 includes a diffuser 140 and a discharge plenum 142, that are coupled to each other in flow communication to facilitate channeling air downstream to combustor assembly 104 as discussed further below.

In the exemplary embodiment, combustor assembly 104 includes a substantially circular dome plate 144 that at least partially supports a plurality of fuel nozzles 146. Dome plate 144 is coupled to a substantially cylindrical combustor flowsleeve 148 with retention hardware (not shown in FIG. 2). A substantially cylindrical combustor liner 150 is positioned within flowsleeve 148 and is supported via flowsleeve 148. A substantially cylindrical combustor chamber 152 is defined by liner 150. More specifically, liner 150 is spaced radially inward from flowsleeve 148 such that an annular combustion liner cooling passage 154 is defined between combustor flowsleeve 148 and combustor liner 150. Flowsleeve 148 includes a plurality of inlets 156 which provide a flow path into cooling passage 154.

An impingement sleeve 158 is coupled substantially concentrically to combustor flowsleeve 148 at an upstream end 159 of impingement sleeve 158, and a transition piece 160 is coupled to a downstream end 161 of impingement sleeve 158. Transition piece 160 facilitates channeling combustion gases generated in chamber 152 downstream to a turbine nozzle 174. A transition piece cooling passage 164 is defined between impingement sleeve 158 and transition piece 160. A plurality of openings 166 defined within impingement sleeve 158 enable a portion of air flow from compressor discharge plenum 142 to be channeled into transition piece cooling passage 164.

In operation, compressor assembly 102 is driven by turbine assembly 106 via shaft 108 (shown in FIG. 1). As compressor assembly 102 rotates, it compresses air and discharges compressed air into diffuser 140 as indicated in FIG. 2 with a plurality of arrows. In the exemplary embodiment, the majority of air discharged from compressor assembly 102 is channeled through compressor discharge plenum 142 towards combustor assembly 104, and a smaller portion of air discharged from compressor assembly 102 is channeled downstream for use in cooling engine 100 components. More specifically, a first flow leg 168 of the pressurized compressed air within plenum 142 is channeled into transition piece cooling passage 164 via impingement sleeve openings 166. The air is then channeled upstream within transition piece cooling passage 164 and discharged into combustion liner cooling passage 154. In addition, a second flow leg 170 of the pressurized compressed air within plenum 142 is channeled around impingement sleeve 158 and injected into combustion liner cooling passage 154 via inlets 156. Air entering inlets 156 and air from transition piece cooling passage 164 is then mixed within passage 154 and is then discharged from passage 154 into fuel nozzles 146 wherein it is mixed with fuel and ignited within combustion chamber 152.

Flowsleeve 148 substantially isolates combustion chamber 152 and its associated combustion processes from the outside environment, for example, surrounding turbine components. The resultant combustion gases are channeled from chamber 152 towards and through a transition piece combustion as stream guide cavity 160 that channels the combustion gas stream towards turbine nozzle 174.

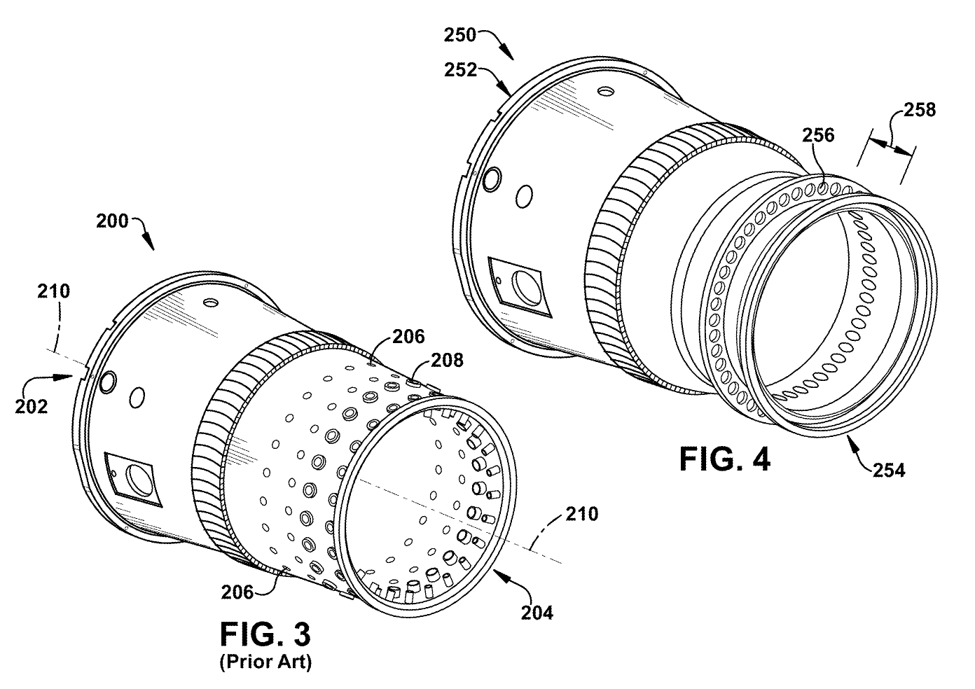

FIG. 3 is a perspective view of a known flowsleeve 200 that may be used with combustor assembly 104. Flowsleeve 200 is substantially cylindrical and includes an upstream end 202 and a downstream end 204. Upstream end 202 is coupled to dome plate 144 (shown in FIG. 2) and downstream end 204 is coupled to impingement sleeve 158 (shown in FIG. 2). Combustor liner 150 (shown in FIG. 2) is coupled radially inward from flowsleeve 200 such that cooling passage 154 (shown in FIG. 2) is defined between flowsleeve 200 and combustor liner 150.

Flowsleeve 200 also includes a plurality of inlets 206 and thimbles 208 defined adjacent downstream end 204. Inlets 206 and thimbles 208 are substantially circular and are oriented substantially perpendicular to a flowsleeve center axis 210. Furthermore, thimbles 208 extend substantially radially inward from flowsleeve 200 such that airflow is discharged from thimbles 208 and inlets 206 from around impingement sleeve 158, radially inward through flowsleeve 200, and into combustion liner cooling passage 154. The radial flow direction of airflow entering passage 154 through inlets 206 and thimbles 208 substantially reduces the axial momentum of airflow and creates a barrier to air flowing within passage 154 from transition piece cooling passage 164. Furthermore, the radial length of thimbles 208 creates an obstruction to airflow channeled from transition piece cooling passage 164. As such, a pressure drop of the airflow results within combustion cooling passage 154. The resulting pressure drop may cause disproportional cooling around combustor liner 150.

FIG. 4 is a perspective view of an exemplary embodiment of a flowsleeve 250 that may be used with combustor assembly 104. Flowsleeve 250 is substantially cylindrical and includes an upstream end 252 and a downstream end 254. Upstream end 252 is coupled to dome plate 144 (shown in FIG. 2) and downstream end 254 is coupled to impingement sleeve 158 (shown in FIG. 2). Combustor liner 150 (shown in FIG. 2) is coupled radially inward from flowsleeve 250 such that combustion liner cooling passage 154 (shown in FIG. 2) is defined between flowsleeve 250 and combustor finer 150.

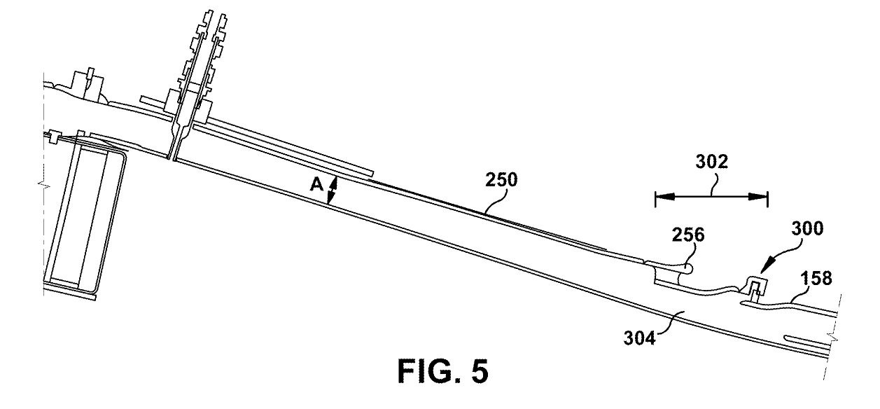

The flowsleeve 250 is configured to have a substantially constant annulus height A (FIG. 5). The substantially constant annulus height A provides the combustor assembly 104, as embodied by the invention, with reduced or essentially eliminated hot spots, which may have been evident with known flowsleeves with annulus configurations. These prior annulus configurations may have been provided by inconsistent widths in the flow paths, which could result in reduced effectiveness of surface treatments, such as, but not limited to, on any of the hot gas path parts, discussed herein. These hot gas path parts, as embodied by the invention, include, but are not limited to, the flow sleeve, the combustion liner, associated features, and the like.

Flowsleeve 250 also includes a plurality of injectors 256 spaced circumferentially about flowsleeve 250 at a distance 258 upstream from downstream end 254. In the exemplary embodiment, injectors 256 are substantially circular and each has a large length/diameter ratio. In an alternative embodiment, injectors 256 are substantially rectangular slots having a width that is larger than a slot height. Moreover, injectors 256 are configured to substantially axially eject airflow from around impingement sleeve 158 through flowsleeve 250 and into combustion liner cooling passage 154. More specifically, airflow ejected from injectors 256 enters passage 154 in a generally axial direction that is substantially the same direction as the direction of flow discharged into passage 154 from airflow channeled into passage 154 from passage 164, and in substantially the same direction as airflow channeled into passage 154 from passage 164. Furthermore, injectors 256 are configured to accelerate airflow ejected therefrom. An annular gap (not shown) is defined between flowsleeve 250 and combustor liner 150 within distance 258. Injectors 256 and the annular gap facilitate regulating pressure in airflow entering combustion liner cooling passage 154.

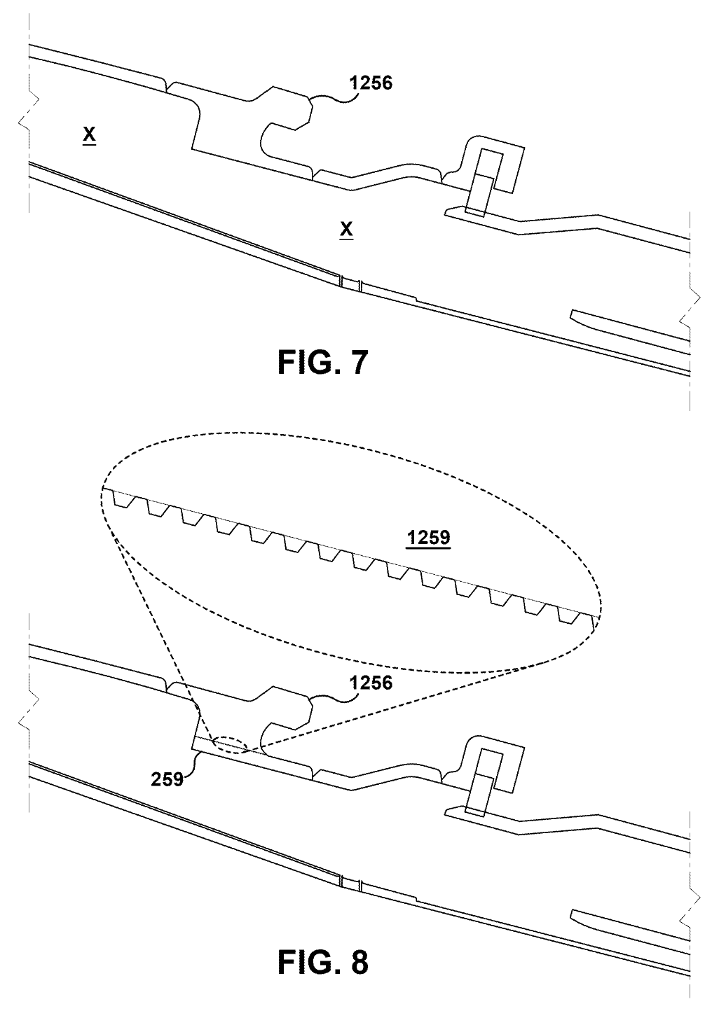

FIG. 5 is a cross-sectional view of flowsleeve 250 and an impingement sleeve/flowsleeve interface 300. Specifically, FIG. 5 illustrates the interface 300 defined between the coupling of flowsleeve 250 and impingement sleeve 158. Furthermore FIG. 5 generally illustrates a cross-sectional view of the axial injection geometry of injectors 256. While details of the axial injection geometry of injectors 256 are provided in FIG. 7 et seq. Specifically, flowsleeve 250 is oriented such that injectors 256 are positioned an axial distance 302 upstream from interface 300. As such, an annular gap 304 defined at the intersection region of flowsleeve 250 and impingement sleeve 158 has an axial length 302. Annular gap 304 facilitates regulating air flow from transition piece cooling passage 164.

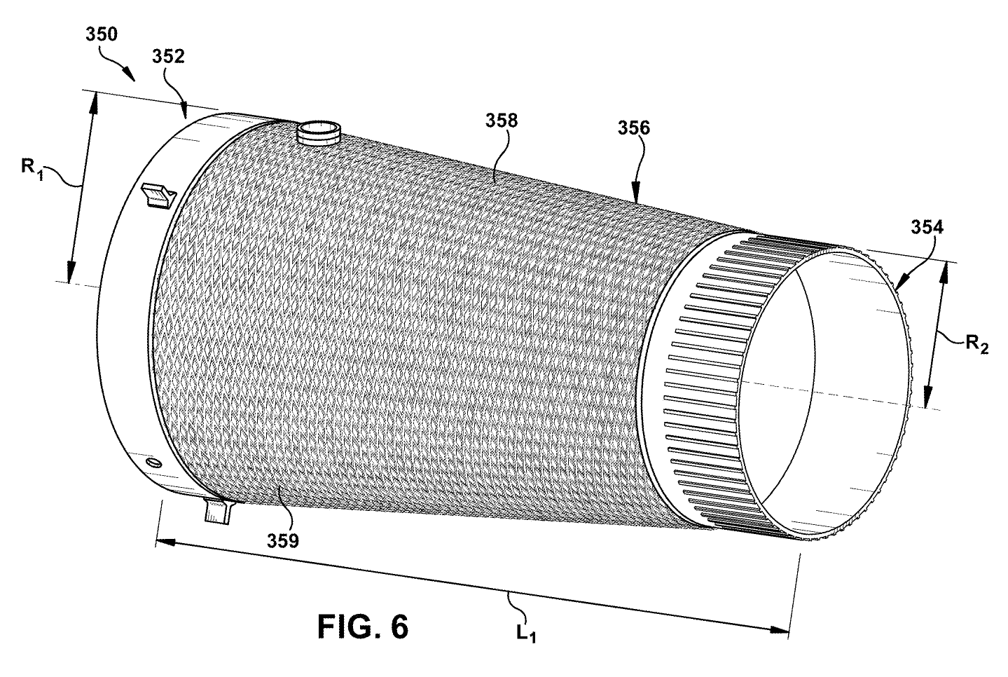

FIG. 6 is a perspective view of an exemplary combustor liner 350 that may be used with combustor assembly 104. Combustor liner 350 is substantially cylindrical and includes an upstream end 352 and a downstream end 354. In the exemplary embodiment, upstream end 352 has a radius R₁ that is substantially larger than a radius R₂ of downstream end 354. Upstream end 352 receives a fuel/air mixture from fuel nozzles 146 and discharges the fuel/air mixture into transition piece 160. Combustor liner 350 is oriented within flowsleeve 250 such that flowsleeve 250 and combustor liner 350 define combustion finer cooling passage 154. Cooling air received in combustion liner cooling passage 154 is channeled upstream and across a surface 356 of combustor liner 350 to facilitate cooling combustor liner 350.

Combustor liner surface 356 is configured with a plurality of grooves 358 defined thereon that facilitate circumferentially distributing the airflow from injectors 256 across liner surface 356. In the exemplary embodiment, grooves 358 are configured in a crisscrossed pattern across a length L₁ of combustor liner surface 356 such that diamond shaped raised portions 359 are defined between grooves 358. In alternative embodiments, grooves 358 may be configured in other geometrical patterns.

FIG. 7 is an illustration of an exemplary configuration for injector 1256 that can be used in an exemplary flowsleeve and an impingement sleeve/flowsleeve interface that may be used with the combustor assembly shown in FIG. 2, as embodied by the invention. In FIG. 7, the configuration of the injector 1256 is chamfered, segmented, or provided by essentially straight segments, which form the inlet of the injector 1256. The chamfered configuration of the injector 1256 in FIG. 7 comprises 6 segments, however, this configuration is merely exemplary and is not intended to limit the combustion assembly, as embodied by the invention. The injector 1256 may have a chamfered configuration with any number of segments. The chamfered configuration of injector 1256 is intended to reduce losses at the entrance to the flowsleeve 250.

FIG. 7 also illustrates areas of controlled cooling annulus X in the flowsleeve 250 for the combustion assembly, as embodied by the invention. These areas of controlled cooling annulus X are proximate the injector 256 (FIG. 5) or 1256 (FIG. 7), are located “inboard” of injection slot. These areas of controlled cooling annulus X maintain coolant flow velocity and convective heat transfer coefficients in the flowsleeve 250 by controlling the flow there through.

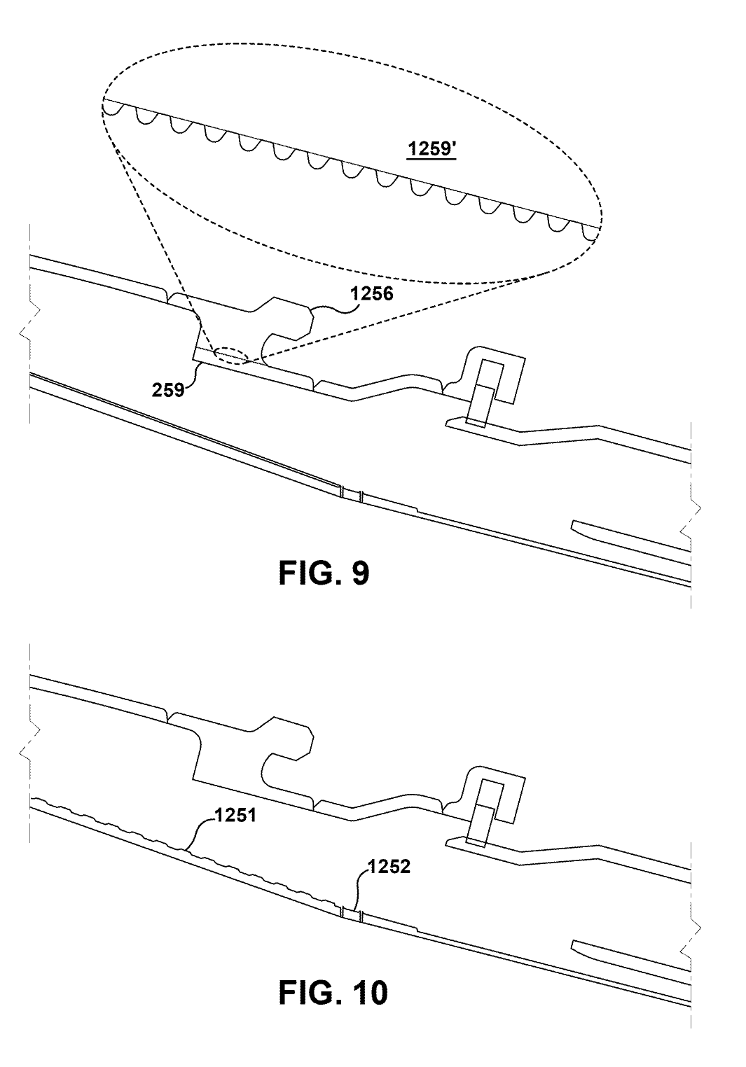

FIGS. 8 and 9 are illustrations of various configurations of a trailing edge 259 of the injectors 256 and 1256 in the combustion assembly, as embodied by the invention that can be used in an exemplary flowsleeve and an impingement sleeve/flowsleeve interface that may be used with the combustor assembly shown in FIG. 2. In these Figures, the trailing edge treatments create turbulations or irregular surface configurations in the flowsleeve 250, as embodied by the invention. These trailing edge treatments create periodic turbulence and flow disturbance to improve mixing between the two air streams. In FIG. 8, the trailing edge treatments are provided in the form of chevrons 1259, while in FIG. 9, the trailing edge treatments are provided in the form of “scallops” or arcuate dimples or structures. The trailing edge treatments illustrated herein are merely exemplary of the various configurations, and other geometries are within the scope of the invention. For example, and in no way limiting of the invention, scalloped and chevron configurations can be used together, such as, but not limited to, in an alternating fashion, a series of scallops then chevrons, deviations of depths either or both of the scalloped and chevron configurations, and other similar scalloped and chevron configurations.

Further, FIG. 10 illustrates another configuration at the injectors 256 (or 1256) of the flowsleeve 250 that can be used in an exemplary flowsleeve and an impingement sleeve/flowsleeve interface that may be used with the combustor assembly shown in FIG. 2, in the combustion assembly, as embodied by the invention. In FIG. 10, the combustion liner 350 comprises a turbulated section at 1251 with rib turbulators at 1252. The turbulated section 1251 and rib tribulators 1252 enhances heat transfer in the liner 350 and the combustion assembly, as embodied by the invention. Therefore, impingement cooling therein may not be needed.

In the above exemplary embodiments, the features of the Figures may be used individually, one feature in combination with any other feature, or each of the features together.

During operation of engine 100 cooling air is discharged from plenum 142 such that it substantially surrounds impingement sleeve 158. First flow leg 168 enters transition piece cooling passage 164 through openings 166. First flow leg 168 cools transition piece 160 by traveling upstream through transition piece cooling passage 164. First flow leg 168 continues through annular gap 304 and discharges into combustion liner cooling passage 154. Second flow leg 170 flows around impingement sleeve 158 and enters combustion liner cooling passage 154 through injectors 256. Within combustion finer cooling passage 154, the first and second flow legs 168 and 170 mix and continue upstream to facilitate cooling combustor liner 350.

The configuration of injectors 256 increases the velocity of cooling air within second flow leg 170. The increased velocity facilitates enhanced heat transfer between the cooling air and combustor liner 350. Annular gap 304 facilitates regulating flow of first flow leg 168 into combustion cooling passage 154. As such, injectors 256 and annular gap 304 facilitate balancing the pressure and velocity of the two flow legs 168 and 170 such that a balanced flow path results from the mixing of the two flow paths.

Furthermore, due to the axial configuration of injectors 256, the second flow leg 170 does not create an air dam, which restricts the flow of first flow leg 168. As a result, the axial configuration of injectors 256 facilitates increasing dynamic pressure recovery within the resultant flow path. By balancing pressure loss and velocity within combustion liner cooling passage 154, injectors 256 and annular gap 304 facilitate substantially uniform heat transfer between combustor liner 350 and the cooling air.

Moreover, grooves 358 of combustor liner surface 356 facilitate enhancing the heat transfer between cooling air and combustor liner 350. Specifically, grooves 358 facilitate circumferentially distributing cooling air from injectors 256 and facilitate creating a uniform heat transfer coefficient distribution across the length and circumference of combustor liner 350. In addition, grooves 358 facilitate allowing high velocity cooling air to facilitate improving heat transfer.

The above-described apparatus and methods facilitate providing constant heat transfer between cooling air and a combustor liner, while maintaining an overall pressure of the gas turbine engine. Specifically, the injectors facilitate reducing pressure losses by injecting the cooling air of the second flow leg axially such that dynamic pressure recovery is increased between the first and second flow leg. Furthermore, the enhancements to the combustor liner facilitate greater heat exchange between the combustor liner and the cooling air.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Although the apparatus and methods described herein are described in the context of a combustor assembly for a gas turbine engine, it is understood that the apparatus and methods are not limited to combustor assemblies or gas turbine engines. Likewise, the combustor assembly components illustrated are not limited to the specific embodiments described herein, but rather, components of the combustor assembly can be utilized independently and separately from other components described herein.

While the invention has been described in terms of various specific embodiments, those skilled in the art will recognize that the invention can be practiced with modification within the spirit and scope of the claims.

What is claimed is:

1. A combustor assembly comprising:
a combustor liner having a centerline axis and defining a combustion chamber therein; and
an annular flowsleeve coupled radially outward from said combustor liner such that an annular flow path is defined substantially circumferentially between said flowsleeve and said combustor liner, the annular flowsleeve defining at least one injector from the flowsleeve to the combustor liner, said flowsleeve comprises a plurality of inlets configured to inject cooling air there from in a substantially axial direction into said annular flow path to facilitate cooling said combustor liner, the at least one injector comprising a trailing edge, the trailing edge comprises at least one of turbulations and irregular surface configurations, wherein the at least one of turbulations and irregular surface configurations create periodic turbulence and flow disturbance to improve mixing between air streams therein.

2. A combustor assembly according to claim 1, wherein the at least one of turbulations and irregular surface configurations comprise a profile with at least one of a scallops, chevrons, or combinations thereof.

3. A combustor assembly according to claim 1, wherein the at least one of turbulations and irregular surface configurations comprise a profile with chevrons.

4. A combustor assembly comprising:
a combustor liner having a centerline axis and defining a combustion chamber therein; and
an annular flowsleeve coupled radially outward from said combustor liner such that an annular flow path is defined substantially circumferentially between said flowsleeve and said combustor liner, the annular flowsleeve defining at least one injector from the flowsleeve to the combustor liner, said injector comprising an inlet, the inlet comprising at least one of a chamfered, segmented, and straight segments.

5. A combustor assembly comprising:
a combustor liner having a centerline axis and defining a combustion chamber therein, the combustion liner comprising a turbulated section with rib turbulators; and
an annular flowsleeve coupled radially outward from said combustor liner such that an annular flow path is defined substantially circumferentially between said flowsleeve and said combustor liner, the annular flowsleeve defining at least one injector from the flowsleeve to the combustor liner, said injector comprising an inlet, the inlet comprising at least one of a chamfered, segmented, and straight segments.

6. A combustor assembly in accordance with claim 1 further comprising a transition piece coupled to said combustor liner; and an impingement sleeve coupled radially outward from said transition piece such that an annular transition piece cooling flow path is defined between said transition piece and said impingement sleeve, said transition piece cooling flow path configured facilitate increasing dynamic pressure recovery within said flow path.

7. A combustor assembly in accordance with claim 1 further comprising an annular flow gap defined between said combustor liner and said flowsleeve, said annular flow gap configured to regulate flow from said transition piece cooling flow path into said annular flow path.

8. A combustor assembly in accordance with claim 1 wherein said plurality of inlets facilitate reducing inlet losses within said annular flow path

9. A combustor assembly in accordance with claim 1 wherein said plurality of inlets facilitate increasing cooling of said transition piece within said annular flow path.

10. A combustor assembly in accordance with claim 1 wherein said plurality of inlets are each substantially circular and facilitate increasing a velocity of cooling air discharged therefrom.

11. A combustor assembly in accordance with claim 1 wherein an exterior surface of said combustor finer comprises surface enhancements that facilitate increasing heat transfer between said combustor liner and cooling air flowing through said annular flow path.

12. A combustor assembly in accordance with claim 2 further comprising a transition piece coupled to said combustor finer; and an impingement sleeve coupled radially outward from said transition piece such that an annular transition piece cooling flow path is defined between said transition piece and said impingement sleeve, said transition piece cooling flow path configured facilitate increasing dynamic pressure recovery within said flow path.

13. A combustor assembly in accordance with claim 2 further comprising an annular flow gap defined between said combustor liner and said flowsleeve, said annular flow gap configured to regulate flow from said transition piece cooling flow path into said annular flow path.

14. A combustor assembly in accordance with claim 2 wherein said plurality of inlets facilitate reducing inlet losses within said annular flow path

15. A combustor assembly in accordance with claim 2 wherein said plurality of inlets facilitate increasing cooling of said transition piece within said annular flow path.

16. A combustor assembly in accordance with claim 2 wherein said plurality of inlets are each substantially circular and facilitate increasing a velocity of cooling air discharged therefrom.

17. A combustor assembly in accordance with claim 2 wherein an exterior surface of said combustor liner comprises surface enhancements that facilitate increasing heat transfer between said combustor liner and cooling air flowing through said annular flow path.

18. A combustor assembly in accordance with claim 3 further comprising a transition piece coupled to said combustor liner; and an impingement sleeve coupled radially outward from said transition piece such that an annular transition piece cooling flow path is defined between said transition piece and said impingement sleeve, said transition piece cooling flow path configured facilitate increasing dynamic pressure recovery within said flow path.

19. A combustor assembly in accordance with claim 3 further comprising an annular flow gap defined between said combustor liner and said flowsleeve, said annular flow gap configured to regulate flow from said transition piece cooling flow path into said annular flow path.

20. A combustor assembly in accordance with claim 3 wherein said plurality of inlets facilitate reducing inlet losses within said annular flow path

21. A combustor assembly in accordance with claim 3 wherein said plurality of inlets facilitate increasing cooling of said transition piece within said annular flow path.

22. A combustor assembly in accordance with claim 3 wherein said plurality of inlets are each substantially circular and facilitate increasing a velocity of cooling air discharged therefrom.

23. A combustor assembly in accordance with claim 3 wherein an exterior surface of said combustor finer comprises surface enhancements that facilitate increasing heat transfer between said combustor liner and cooling air flowing through said annular flow path.
